(19) United States
(12) Patent Application Publication
(10) Pub. No.: US 2009/0127450 A1
(43) Pub. Date: May 21, 2009

(54) METHOD FOR THE RELATIVE MEASUREMENT OF THE FLUORESCENCE QUANTUM EFFICIENCY OF DYES IN SOLUTION

(75) Inventors: Joel Bleuse, Seyssins (FR); Sophie Carayon, Montpellier (FR); Eric Delamadeleine, St Martin Le Vinoux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/577,926

(22) PCT Filed: Oct. 25, 2005
(86) PCT No.: PCT/FR05/50896

§ 371 Date: Apr. 25, 2007

(30) Foreign Application Priority Data
Oct. 26, 2004 (FR) 0452443

(51) Int. Cl. G01D 18/00; G01J 1/58

(52) U.S. Cl. 250/252.1; 250/458.1; 250/459.1

(57) ABSTRACT

A method for measurement of relative fluorescence quantum efficiency of a dye, including: a) for at least two different concentrations of the dye in solution in a solvent, exciting the dye with electromagnetic radiation and measuring the photoluminescence of the dye that has been excited by the radiation and of the signal transmitted through the cell containing the dye; b) comparing the data measured with the photoluminescence and transmission data of a reference dye; and c) calculating the relative fluorescence quantum efficiency of the dye.

### TECHNICAL AREA AND PRIOR ART

The invention concerns a new method for relative measurement of the fluorescence quantum yield of dyes in solution. It applies to any organic or inorganic dye, e.g. semiconductor nanocrystals.

Numerous applications of organic and inorganic dyes are based on the capability of these dyes to emit light, e.g. using them as fluorescent marker.

Fluorescence quantum yield quantifies the efficacy of these dyes, it is equal to the ratio of the number of photons emitted by this solution to the number of absorbed photons. It forms an important parameter for manufacturers and users of these products, and systematic and reliable measurement of this quantum yield is desirable.

Measurements of fluorescence quantum yield are known on organic dyes in order to determine reference dyes, whose quantum yield is therefore subsequently known, allowing them to be used as standards.

Several methods for absolute measurement of fluorescence quantum yield have therefore been used: the calorimetric method, the photo-acoustic method, the method using an integrating sphere and Vavilov's method are the most known (J. N. Demas et al, J. Phys. Chem. 75, p 991-1023, (1971)).

These methods are cumbersome to implement since they are time-consuming, cannot be automated and relate to the area of laboratory metrology. In addition, their reliability is limited since accuracy varies from 5% to 10%. Also, these measurements often require concentrated solutions, which is difficult to obtain with products for which only small quantities are available, such as semiconductor nanocrystals for example.

For these reasons, the measurement of fluorescence quantum yield in solution is most frequently performed relatively, using the above-cited reference or standard dyes. In this respect, two methods exist (J. N. Demas et al, J, Phys. Chem. 75, p. 991-1007, (1971)).

One method is the so-called <<high optical density>> method, and requires highly concentrated solutions. But, for the above-mentioned reason, this method is not suitable for most inorganic dyes.

The other method is the so-called <<low optical density>> method, and requires more dilute solutions. This method entails comparing the intensity of photoluminescence of a dye, whose quantum yield is known, with the intensity of the sample to be determined.

However, the procedure followed by most laboratories or manufacturers is disputable regarding two points:

1) First, in order to be able to compare the intensity of photoluminescence of two solutions, these must have one same absorbance, which cannon always be ensured when comparing the sample and the reference at a single concentration. It is possible to use this method with subsequent correction of measurements. But the corrective factors are nor always well controlled, and are the source of major error for the value of fluorescence quantum yield.

2) The other difficulty concerns the reproducibility of measurements. For relative measurement, the set-up routinely used comprises a laser beam brought onto the sample by means of a system of optics (mirrors, filters . . . ), a fluorescence cell containing the solution, an optics system to collect luminescence (lenses, diaphragms . . . ) and a detector. Yet, photoluminescence being isotropic, the yield measured by the detector only represents part of the emitted flow. Precise knowledge of the geometry of the set-up is therefore essential, since any change, however small, in the pathway of the laser beam or in the positioning of the cell may lead to considerable error of measurement and poor reproducibility of results.

To conclude, it is found that the relative measurement of fluorescence quantum yield, such as routinely performed, is scarcely reliable, difficult to reproduce and non-automated.

The problem therefore arises of finding a new method and a new device for measuring the relative quantum, yield of a dye.

Preferably, said method and said device can be used to perform measurements over a wide range of concentrations.

### DESCRIPTION OF INVENTION

The invention makes it possible both to perform more accurate measurements of fluorescence quantum yield, and to reduce considerably the time needed to perform these measurements compared with the above-described methods.

The invention concerns a method for measuring the relative fluorescence quantum yield of a dye, comprising:

a) for at least, two, or at least ten or for several dozen, e.g. between 20 and 50 or 100, different dye concentrations:
exciting the dye using electromagnetic radiation,
measuring the photoluminescence of the dye excited by this radiation, and the power of the signal transmitted through the cell containing this dye,

b) comparing these measurements with the same data or corresponding data of photoluminescence and transmission measured on a standard dye,

c) calculating the relative fluorescence quantum yield of the dye.

According to one particular embodiment, the measured data are adequately adjusted to a theoretical function giving changes in photoluminescence in relation to the transmitted signal, from which the parameters are inferred allowing calculation of the fluorescence quantum yield of the sample.

With this method it is possible to overcome uncertainty regarding dye concentration, since this result does not at any time require knowledge either of the concentration of the dye to be measured or of the concentration of the standard dye.

Preferably, the concentration varies decreasingly: measurements start with the highest concentration and end with the weakest concentrations.

This method can be applied firstly to a standard dye (whose fluorescence quantum yield is known) and then to the sample whose quantum yield is to be determined. Or else, the quantum yield of the standard dye is already known and measurement is only made for the dye whose quantum yield is unknown.

The solution under consideration is therefore firstly the standard dye, then the same experiment is conducted under the same geometric conditions on the sample whose yield is to be determined.

Measurement of the power or intensity of incident radiation can be used to normalize the measurements, and to free the measurements of any variation in intensity or power in the beam or incident radiation.

According to one particular embodiment of the invention, in is therefore possible to measure simultaneously the power of the incident beam, the power transmitted through the cell, and the fluorescence signal emitted by the solution.

The beam or incident radiation may derive from a laser, or a non-coherent source e.g. the collimated beam of a source of light-emitting triode type, or a spectrum-filtered white lamp, or any other source able to excite the fluorescence of the measured dyes and whose spectrum does not overlap the emission spectrum of these dyes.

An additional measurement of the beam reflected by the cell, containing the dye, can be used no control the homogeneity of the solution in the cell.

The method of the invention is particularly suitable for measuring the fluorescence quantum yield of inorganic dyes, for examples semiconductor nanocrystals of II-VI type, e.g. CdSe(ZnS). For semiconductors, the invention is all the more of interest since the concentration of nanocrystals, whose weight is most variable, is very difficult to evaluate; but the invention does not require knowledge of this concentration.

The detection means to detect fluorescence and transmitted radiation, as well as the cell and at least part of the means used to define the pathway of the incident radiation are advantageously fixed with respect to each other and/or are fixed onto a table.

The fluorescence cell is preferably a circulation cell, making it possible to vary the concentration of the solution in the cell without its displacement.

In addition, the cell preferably has means for adding a dye and a solvent without adding air bubbles to the cell.

The invention also concerns a device for measuring the relative fluorescence quantum yield of a dye in solution in a solvent, this device comprising:
a fluorescence cell,
means for measuring a fluorescence signal emitted by one excited dye, and to measure a signal transmitted through the dye,
means for calculating the relative quantum yield in relation to data of fluorescence signals emitted by an excited dye, and in relation to a laser signal transmitted through this dye and to corresponding data for a standard dye.

Means may also be provided to cause the concentration of a dye in the cell to vary in relation to time.

The cell may be a circulation fluorescence cell.

Also, the device may additionally comprise means for measuring a signal reflected by the cell.

Means for homogenizing the dye in the cell allow measurements to be made in a homogeneous solution.

Means may be provided to measure variations in the intensity or power of incident radiation on the cell.

According to one embodiment, the calculation means adjust fluorescence signal and transmitted signal data to a theoretical formula.

Both for the device and for the method of the invention, the theoretical formula may be the following:

$$F = \frac{B {ℏω}_{f}}{\sqrt{A} {ℏω}_{i}} ρ \sqrt{T} sinh ( \frac{Δ}{L} ln ( \frac{A}{T} ) ) \qquad ( 5 )$$

or the following formula:

$$F = - \frac{B {ℏω}_{f}}{A {ℏω}_{i}} ρ \frac{Δ}{L} ( T - A ) + {C ( T - A )}^{3} \qquad ( 6 )$$

in which F is proportional to the power of the fluorescence signal, T is proportional to the power of the transmitted signal, ρ is absolute fluorescence quantum yield, ω_{f} is the energy of the photons emitted by the solution, ωᵢ is the energy of the incident photons, B and A are constants and Δ and L are geometric parameters of the cell containing the dye.

Preferably, the calculation means calculate the relative quantum yield of the dye, using the formula:

$${ρ}_{E} = {ρ}_{R} \frac{{( {ℏω}_{f} )}_{R} {( m 1 )}_{E} {( m 2 )}_{E}}{{( {ℏω}_{f} )}_{E} {( m 1 )}_{R} {( m 2 )}_{R}} \qquad ( 9 )$$

in which ω_{f} is the energy of the photons emitted by the solution, ωᵢ is the energy of the incident photons, m1 and m2 are parameters characteristic of evolving fluorescence (F) in relation to the transmitted signal (T), the indices R and E respectively relating to the standard dye and to the sample.

Again preferably, she cell and the measurement means are arranged fixedly with respect to each other.

Means may be provided to define a direction of incidence of radiation.

The injection of a dye solution, then of the solvent intended to dilute this solution, in the cell, may be conducted using automated injection means.

### BRIEF DESCRIPTION OF THE FIGURES

FIG. 1 is a general schematic of a device according to the invention.

FIG. 2 is a diagram of an optical set-up used in one embodiment of a device according to the invention.

FIGS. 3A and 3B are diagrams of a fluorescence cell from a side view, and a cross-sectional view of she fluorescence cell seen from overhead.

FIG. 4 is a graph of R=f(T) for quinine sulphate.

FIG. 5 is a graph of F=f(T) for rhodamine and quinine sulphate.

FIG. 6 is a graph of F=f(T) for rhodamine and CdSe(ZnS) nanocrystals.

FIG. 7 shows data processing means able to be used under the invention.

### DETAILED DESCRIPTION OF ONE EMBODIMENT OF THE INVENTION

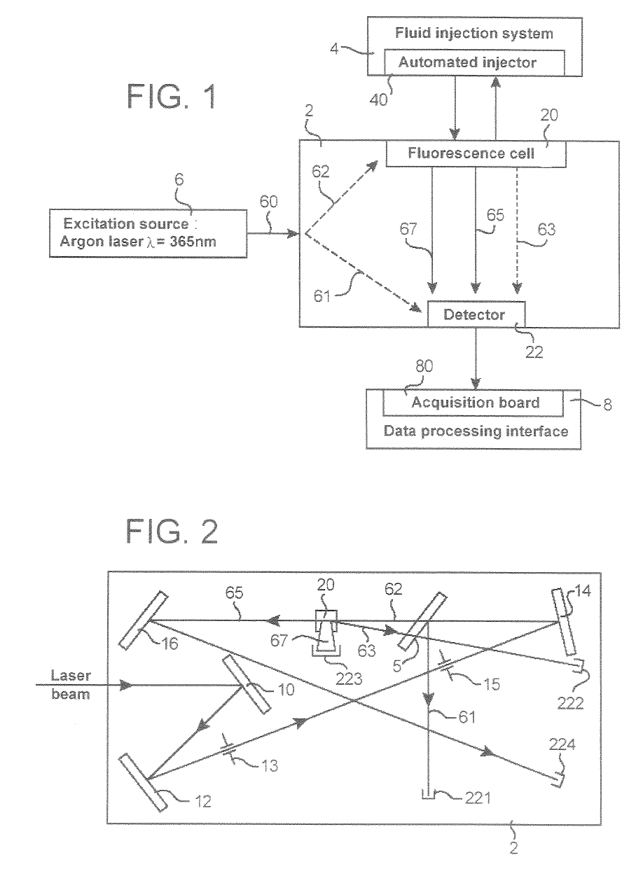

FIG. 1 schematically shows various components of a device which can be used for the invention.

Said device comprises a radiation source 6, or means 6 producing excitation radiation, optical means 2 themselves comprising a fluorescence cell 20 and at least detection means 22 to detect firstly fluorescence optical signals and secondly the signal passing through the cell 20. Reference 22 in FIG. 1 therefore schematically designates a group of detectors rather than a single detector.

Fluidic means 4 are used to inject a dye and a solvent into the cell 20. Preferably, these means, as illustrated FIG. 1, comprise automated injection means 40 for example.

Means 8 for data acquisition and processing are used to collect and process the data supplied by the detector or detectors.

The excitation source 6 is a time-continuous radiation source, e.g. an argon laser at a wavelength of 365 nm.

The incident beam or radiation may be that of a laser, or else of a non-coherent source e.g. the collimated beam of a source of light-emitting triode type, or of a spectrum-filtered white lamp, or any other source able to excite the fluorescence of the measured dyes and whose spectrum does not overlap the emission spectrum of these dyes.

The power of the radiation source is preferably chosen to be fairly low so as not to photo-bleach (destruction by photo-oxidation) the fluorescent particles of the dye, which would distort the measurement.

For example, this power lies between 1 μW and 10 μW or 100 μW and 200 μW.

Part 62 of the radiation 60 emitted by the means 6 is directed towards the cell 20. Another part 61 of this same radiation may be used to measure variations in intensity of the radiation 60 itself, in which case the detection means 22, in addition to the means already mentioned above, also comprise means for detecting this part 61 of the radiation.

The fluidic means 4 (e.g. automated injection means 40 with valve, for example a valve having at least two channels e.g. a six-channel valve of the type used in low pressure liquid chromatography) are connected, when in operation, with the fluorescence cell into which they inject dye and solvent.

From the cell 20, fluorescence radiation 67 is emitted which is detected and measured by means 22, more precisely by the fluorescence radiation detecting means, and radiation 65 is emitted which passes through the cell without being absorbed by the dye and is also detected and measured by means 22, more precisely by the means for detecting transmission radiation.

According to one embodiment, radiation 63 reflected by the cell may also be detected by the detection means 22, by a specific detector. The usefulness of this detection is explained further on.

The means 8 in FIG. 1 may comprise one or more computer interface boards 80 for data acquisition. These boards will enable data from the detection means 22 to be acquired and processed, by coupling to data processing means of microprocessing or PC type for example.

These data processing means may be specially programmed for this purpose and to carry out data processing according to the invention, such as explained further on.

FIG. 2 shows an example of embodiment of optical means 2.

In this figure, the tracing of the incident beam emitted by means 6 (not shown in this figure) is shown as a solid line, and the reference direction is defined by the two diaphragms 13 and 15.

The device has four mirrors 10, 12, 14, 16.

Two detectors 223 and 224 (e.g. photodiodes) are used to measure the intensity or power respectively of firstly the photoluminescence 67 of the dye contained in the cell 20, and secondly of the beam 65 transmitted through this cell, after passing of the dye.

A high-pass filter (e.g. with a cut-off wavelength of 400 nm for an incident beam at 365 nm) can be associated with the detector 223, integrated for example in a support of this detector, in order to cut off any diffusion of the excitation signal (here at λ=365 nm) by impurities.

Detector 223 is preferably placed as close as possible to the cell 20 for maximum signal collection. Optical means for collecting fluorescence towards the detectors may be added (lens, and/or mirrors, and/or integrating sphere).

On the contrary, detector 224 is preferably placed as far away as possible from the cell 20, for maximum reduction of the ratio of the fluorescence signal to the excitation signal (fluorescence is an emission in all the available solid angle, its intensity decreasing inversely to the square of the distance, unlike the laser beam).

A glass slide 5 can be positioned ahead of the cell 20, to sample a small part 61 of the incident signal beam, and to send it to the detector 221 (FIG. 2). This signal is used as reference. Aided by a detector 221 (e.g. a photodiode) it enables measurement of variations in intensity or power of the incident beam.

This measurement could just as well be made outside the system shown FIG. 2, for example close to the radiation source 6 (not shown in this FIG. 2).

A fourth detector 222 (e.g. again a photodiode) can be used to measure or control the intensity or power of the signal 63 reflected by the inlet and outlet windows of the cell 20.

This detector 222 is preferably positioned as close as possible to the mirror 14 so that the reflected beam 63 (and hence also the incident beam 62) forms a small angle with the normal to the cell (approximately 3.5°). A beam with near-normal incidence allows maximized signal collection on the detector 222, and simplifies calculations of the reflection and transmission coefficients on the cell.

The two diaphragms 13, 15, are preferably definitively fixed, and define a reference direction.

The two first mirrors 10, 12 are adjustable and are used to align the beam in this reference direction.

Downstream, mirrors 14, 16, the supports of detectors 223, 224, and the cell 20 can be permanently secured after their position has been optimized.

The fixing or securing of the elements positioned downstream of the mirrors 10, 12, makes it possible to define a fixed measuring configuration.

For use of the device, it is preferably sought to fix the geometric parameters of the set-up (mirrors, diaphragms) so that the pathway of the beam 62 through the cell and towards the detectors is always the same.

Preferably, the detection means 223, 224 to detect fluorescence and transmitted radiation, as well as the cell 20 and at least part of the means 13, 14, 15, 16 enabling the pathway of incident radiation 62 to be defined, are fixed relative to each other.

In this way it becomes possible to work within a stable configuration and geometry.

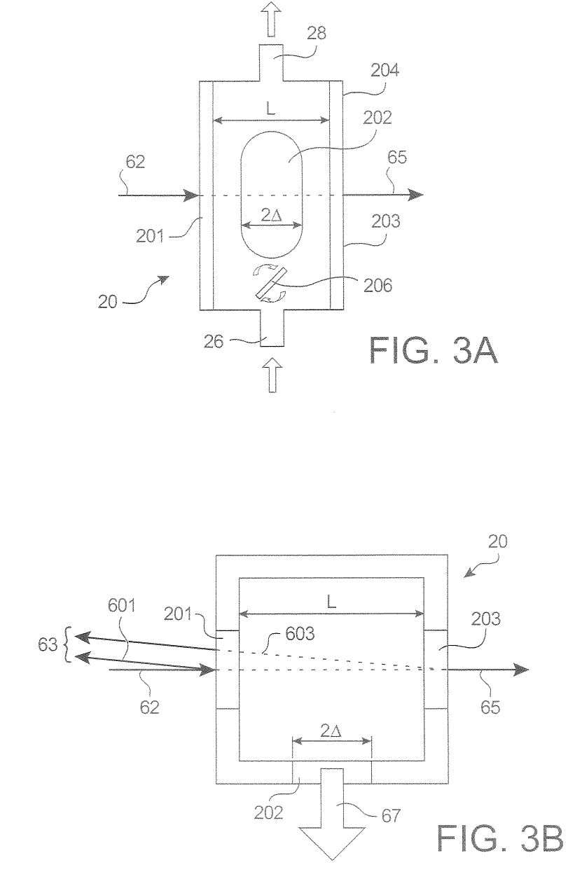

An example of a cell 20 which can be used with a device according to the invention is shown FIGS. 3A and 3B.

The volume of this cell lies between 0.1 ml and 10 ml for example.

Of width L (it is in fact the length of the beam pathway when it passes through the entire cell) it has walls 201, 203, e.g. in quartz, to allow the entry and exit of excitation radiation 62 (of power Pi) and of transmission radiation 65 (of power Pt).

Laterally, a window 202 e.g. of oblong shape, also in quartz, of width 2Δ, offers an outlet 67 for fluorescence radiation (of power Pf).

The fluorescence signal is therefore measured via this oblong window 202.

In FIG. 3B, the quartz walls are shown in grey when they are opaque, and in white in their transparent parts.

The beam 63 (of power Pr) reflected by the cell 20 in fact comprises two components 601, 603 reflected firstly by the inlet window 201 and secondly by the outlet window 203.

Measurement of signal 63 reflected on the cell 20 is used to verify the homogeneity of the solution in this cell.

Means 26, 28 enable a fluid no be added to the cell and to be removed from the cell, optionally assisted by pumping means.

The cell 20 is preferably a circulation cell, making it possible to vary the concentration of the solution in the cell without its displacement, which also contributes towards the geometric stability of the set-up.

With said cell, the starting product can for example be a concentrated solution to which the solvent is continuously injected to dilute in, whilst conducting measurements.

Also, by injecting the solvent with automated injection means, e.g. at rates of 100 μL/min to 200 μL/min, it is possible to obtain several thousand point measurements in 10 minutes, which considerably increases accuracy, while maintaining the experimental time to well below the time needed in known techniques which require several hours to obtain measurements of similar accuracy.

In order to maintain a homogeneous solution in the cell, homogenizing means 206 can be used e.g. a magnetic rod (of small size: for example L=2 mm, ø=1 mm) placed in the cell and set in movement by means of a magnetic stirrer, having two magnets for example driven in rotation by a motor (not shown in the figure).

The signals from one detectors are sent to electronic acquisition means and means for processing these signals.

According to one example of processing, these signals detected by the photodiodes are converted, amplified and filtered by several circuits, each circuit being positioned behind each of the detectors.

These signals are sent to a computer via an acquisition board (Keithley) and are processed by a programme.

The measurements made by the different. detectors are made near-simultaneously, preferably at a fast acquisition rate e.g. between one acquisition (in fact: simultaneous acquisitions) every 5 is or every 10 ms, and one every 100 ms or every 200 or 300 ms. According to another example, one acquisition is made every 50 ms for example.

Generally the detectors used are all preferably silicon photodiodes.

Examples of signal processing are given below.

The set-up may be designed to be compact for easy transport.

For this purpose, the optical means and the detection means may be fixed on a plate, e.g. in aluminium of size 25 cm×15 cm×1 cm for example. This plate rests on three feet of adjustable height which can be easily fixed to the table used.

An example of a complete set-up comprises:
1 argon laser 6,
1 plate mounted on 3 feet,
4 ultraviolet interferential mirrors 10, 12, 14, 16, each of diameter 12.7 mm, with their supports fixed to the plate,
2 diaphragms 13, 15, of diameter 0.8 mm,
1 separating slide 5 and its support,
1 circulation 20 fluorescence cell (volume=100 μL),
1 magnetic stirrer and a magnetic rod 206 in the cell,
1 high-pass filter with a cut-off wavelength of 400 nm, at the cell exit on the side of the observation window of emitted fluorescence,
4 detectors 221, 222, 223, 224 (photodiodes) and their supports,
4 printed circuits (one for each detector), one current/voltage converter and an amplifier,
1 acquisition board,
1 printed circuit ensuring the link towards the acquisition board,
1 automated injector,
1 six-channel valve and syringes connected to the valve.

To obtain fluorescence quantum yield from the magnitudes measured during the experiment, various experimental data processing methods may be used, but which do not all have the same accuracy.

Certain processing methods give good results when the concentration of the solution is intermediate, but error in the calculation of quantum yield diverges at high and low concentrations.

Preferably, use is made of the method which gives the best accuracy for fluorescence quantum yield, and which comprises tracing of the luminescence signal in relation to the transmitted signal, hence in relation to concentration, with adjustment of the curve obtained using a theoretical formula.

Relative error on quantum yield is therefore averaged over the totality of measurement points.

The theoretical expressions, of the different magnitudes measured, depend upon on the geometry of the fluorescence cell.

The theoretical expression of the transmitted signal (Pt) is:

$$Pt = APi exp ( - 2 X ) , writing X = α \frac{L}{2} \qquad ( 1 )$$

With A being a constant, α the absorbance of the tested solution and L the width of the fluorescence cell.

The theoretical expression of the fluorescence signal (Pf) is:

$$Pf = B \frac{{ℏω}_{f}}{{ℏω}_{i}} ρ Pi exp ( - X ) sinh ( \frac{2 Δ}{L} X ) writing X = α \frac{L}{2} \qquad ( 2 )$$

With B being a constant, ωf the energy of the photons emitted by the solution, hωi the energy of the incident photons (derived from the laser), ρ the fluorescence quantum yield and Δ a geometric parameter of the fluorescence cell (FIG. 3A).

Normalization may be performed by dividing the expressions found by the power of the incident signal (Pi) which, by writing T=Pt/Pi and F=Pf/Pi, gives:

T=A exp(−2×) according to equation (1) (3)

$$F = B \frac{{ℏω}_{f}}{{ℏω}_{i}} ρexp ( - X ) sinh ( \frac{2 Δ}{L} X ) according to equation ( 2 ) \qquad ( 4 )$$

According to equations (3) and (4), the theoretical expression of curve F=f(T) is:

$$F = \frac{B {ℏω}_{f}}{\sqrt{A} {ℏω}_{i}} ρ \sqrt{T} sinh ( \frac{Δ}{L} ln ( \frac{A}{T} ) ) \qquad ( 5 )$$

It is possible to make an adjustment of the measured points relative to this complete expression. However, if very little material is available, only the measurements at the weak concentrations are obtained. It is then simpler, in this case, to make the adjustment of the experimental measurements relative to an expression approaching formula (5), for example by performing a development in limited series of equation (5) around T=A.

The approximated expression used is the following for example:

$$F = - \frac{B {ℏω}_{f}}{A {ℏω}_{i}} ρ \frac{Δ}{L} ( T - A ) + {C ( T - A )}^{3} \qquad ( 6 )$$

With C being a parameter whose expression in known, but whose value is not necessary for calculating quantum yield.

Adjustment of the curve F=f(T) may therefore be made with respect to three parameters:

$$m 1 = - \frac{B {ℏω}_{f}}{A {ℏω}_{i}} ρ \frac{Δ}{L} m 2 = A and m 3 = C . \qquad ( 7 )$$

The experimental data show a slight curvature, provided by equation (6). To obtain a correct value of m1, the adjustment takes into account the proportional term at (T−A)³, even though m3 is not subsequently used.

This procedure may be firstly applied to the standard dye: (m1)_{R}, (m2)_{R} et (m3)_{R} are then obtained. According to one variant, these parameters are known from a prior measurement made for this same standard dye.

This procedure is applied to the sample, which gives (m1)_{E}, (m2)_{E} and (m3)_{E}.

The relative quantum yield ρ_{E} of the sample is obtained using the ratio (m1)_{E}/(m1)_{R}:

$$\frac{{( m 1 )}_{E}}{{( m 1 )}_{R}} = \frac{- \frac{B}{{A}_{E}} \frac{{( {ℏω}_{f} )}_{E}}{ℏ {ω}_{i}} {ρ}_{E} \frac{Δ}{L}}{- \frac{B}{{A}_{R}} \frac{{( {ℏω}_{f} )}_{R}}{ℏ {ω}_{i}} {ρ}_{R} \frac{Δ}{L}} according to equation ( 7 ) \qquad ( 8 )$$

By simplifying equation (8) with the constants B, L and Δ, and by replacing parameter A by m2 found by means of the adjustment made above, the following is obtained:

$${ρ}_{E} = {ρ}_{R} \frac{{( ℏ {ω}_{f} )}_{R} {( m 1 )}_{E} {( m 2 )}_{E}}{{( ℏ {ω}_{f} )}_{E} {( m 1 )}_{R} {( m 2 )}_{R}} \qquad ( 9 )$$

The ratio of the fluorescence energies ω_{f} may be involved since the standard and the sample do not necessarily emit at exactly the same wavelength.

On this account, another corrective factor may also be used, since the efficacy of the fluorescence detector may vary with wavelength.

Other corrections are possible, in particular the correction related to the difference in index between the solvents used for the standard dye and the dye to be measured.

Measurement of the power reflected (Pr) by the front side 201 and the rear side 203 of the cell (FIG. 3B), using detector 222 (FIG. 2), makes it possible to verify the homogeneity of the solution in the cell.

As explained above, with reference to FIG. 3B, Pr is the sum of the two components:

(1) a component 601 reflected by the front side 201 of the cell, i.e. proportional to Pi, hence independent of the concentration of the solution,

(2) a second component 603 reflected by the rear side 203 of the cell 20, and which therefore depends on the solution through which it passes twice.

The theoretical expression of the reflected power is:

Pr=rPi+r′Pt² (10)

in which r and r′ are constants. Normalization is performed as previously by dividing by Pi which, by writing R=Pr/Pi, gives:

R=r+r′T² (11)

This calculation is valid if the solution in the cell is homogeneous since, if this is not the case, complex phenomena come into play and this theoretical expression is not verified. Adjustment of the tracing of R=f(T) relative to a parabola allows verification of the homogeneity of the solution.

The data processing means 8 allow processing of the data measured by the detector using a method such as described above.

Said means are shown FIG. 7 and, in addition to a micro-computer 82 receiving data from the acquisition boards associated with the detectors, and programmed no implement a method according to the invention such as described above, also comprise display means 84 allowing an operator to visualize, for example:
the distribution of the measured points F and T and curve F=f(T),
the corresponding, calculated parameters m1, m2 and optionally C, and the relative fluorescence yield obtained,
optionally the points and curve R=f(T).

Other parameters such as characteristics of the incident beam may also be displayed.

Peripheral means 86, 88 can allow the operator to control the entire measurement, for example the triggering of the radiation source, the duration of measurement, the number of acquisition points . . . etc.

Said means, associated with a set-up such as the one in FIG. 2, mounted on a working table, may be integrated in a dye manufacturing unit, or in a laboratory in which said dyes are routinely used and must be characterized for their quantum yield.

The chief advantages of the invention are the following:

a) the high accuracy of measurement of relative quantum yield, through obtaining magnitudes F and T, and optionally R and I; also, a large number of points can be measured within a fairly short time. In practice, a number of points totaling at least 1000 or 5000, or lying between 1000 or 5000 can be measured within a time of approximately 10 minutes for example, or between 5 nm and 20 nm, which is sufficient to ensure full accuracy of the method. The invention also enables adequate application of the results. The proposed accuracy is better than 3%, without taking into account already existing inaccuracy in respect of the value of the fluorescence quantum yield of the standard dye (absolute measurement method).

b) the reproducibility of measurements in time, guaranteeing a reliable comparison between the standard and the sample by means of the dedicated set-up, whose geometric parameters can be strictly set. It is therefore possible to study ageing, over time, of the fluorescence quantum yield of a solution with good accuracy.

c) the rapidity of measurement and of the method of applying results. The measurements made by the different detectors may be simultaneous or near-simultaneous. In addition, the automation of the set-up using an automated injector and data acquisition means provides fast measurement speed, and considerably reduces experimental time to around 10 to 15 minutes for the measurement of each product, standard and then dye, i.e. a total of approximately 30 minutes to obtain the quantum yield of the dye using expression (9).

d) although it can be used over the entire possible range of concentrations of the dye to be measured, the invention does not require measurements at high concentrations; it also eliminates any need for precise knowledge of the concentration of the dye, since solely the fluorescence and transmitted radiations are used.

Measurements of fluorescence quantum yield were made in relation to rhodamine 6G ethanol, whose absolute quantum yield has been measured using several methods.

The calorimetric method, which appears to have the best accuracy, claims a yield of 94% to within 5% (A. V. Butenin et al., Opt. Spectrosc. 47(5), p. 568-569, November (1979)).

A ‘test’ measurement was first made on an organic dye whose yield is already known in the literature, in order to validate the method.

Then the fluorescence quantum yield of inorganic particles (semiconductor nanocrystals) was measured.

### Example 1

### Relative Measurement of the Fluorescence Quantum Yield of an Organic Dye: Quinine Sulphate

Quinine sulphate, like rhodamine 6G, is one of the most studied dyes, whose quantum yield is therefore the best known. Calorimetric measurements have shown that the yield of quinine in 0.1 N sulphuric acid is 56% to within 7% (B. Gelernt et al., J. Chem. Soc, Faraday Trans. 2, 70, p 939-940, (1974)).

After some optical adjustments, to align the laser beam in the reference direction given by the two diaphragms (FIG. 2), measurement on the standard dye, in this case rhodamine, is ready to perform.

Into the fluorescence cell, 1 mL of a rhodamine solution is injected of concentration C=1 mg/mL in ethanol. Ideally, the concentration of the solution is chosen so that at the start of the experiment, transmission is zero (all the light of the laser beam is absorbed), then rapidly non-zero (i.e. not too concentrated) to limit the acquisition time.

It is possible to use much less concentrated solutions when the quantity of available material is small for example.

Then ethanol is injected via another channel of the <<six-channel>> valve so as not to allow air to enter into the system.

This injection is automated and is made using an automated syringe plunger at a rate of 100 μL/min to 200 μL/min.

The rate is optimized for slow dilution of the solution in order to obtain a sufficient number of measurement points, but not too many so that acquisition does not exceed 10 to 15 min.

Measurement terminates automatically when the fluorescence signal falls to around zero, i.e. there is practically no more rhodamine in the cell.

If desired, it is possible to collect the solution after use. This is not recommended regarding rhodamine since it is the standard, it is therefore preferable to use a fresh solution each time.

On the other hand, this may be useful for dyes for which only a small quantity is available. It is to be noted here that the power of the laser beam is very low, P=1 μW at the input into the optical system i.e. around two times less on the cell owing to losses at the mirrors, diaphragms . . . .

This power is chosen to be fairly low so as not to photo-bleach the fluorescent particles (destruction by photo-oxidation), which would distort measurement.

The same procedure is followed for quinine in 0.1 N sulphuric acid. The concentration of the starting solution is C=4.5 mg/mL.

Once acquisition is completed, the measurements are processed.

Both for the standard and for the sample, the transmitted signal, the reflected signal and the fluorescence signal are normalized using the incident signal.

Then R=f(T) and F=f(T) are traced for both dyes.

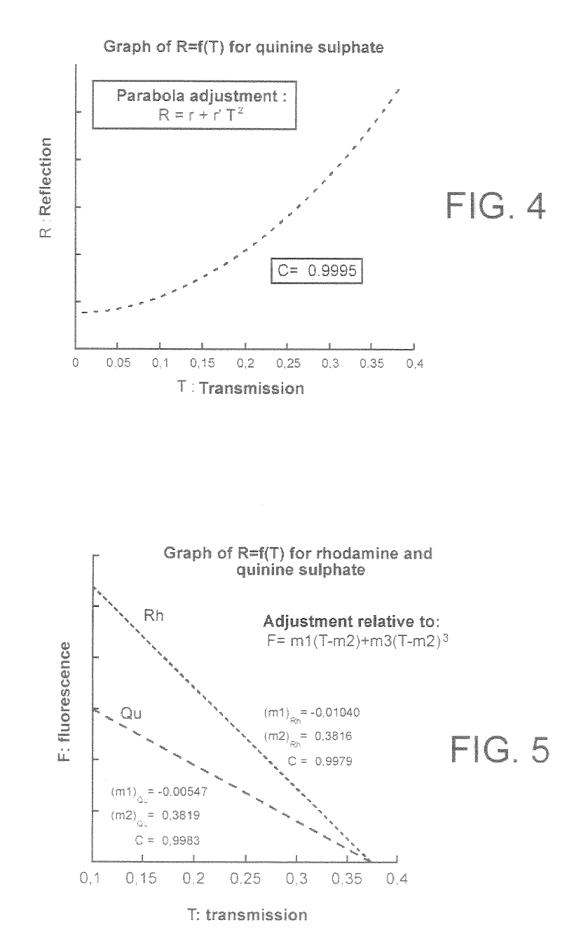

Graph R=f(T) in FIG. 4, shows the experimental points and the adjustment (dotted line) using theoretical formula n^{o} 11.

This adjustment of the curve R=f(T) by a parabola is of very good quality: the correlation coefficient, denoted C, of the adjustment relative to the curve is very close to 1. This allows verification that the solution was homogeneous at the time of acquisition for quinine sulphate (FIG. 4). This same verification is made for rhodamine (data not shown in the figure).

The adjustment of curves F=f(T) is made using theoretical formula n^{o} 6, after setting aside the points representing high concentrations, since this approximated expression is only valid for weak concentrations, in the vicinity of F=0.

Those points representing high concentrations are discarded, from the adjustment since they may contain phenomena of emission reabsorption.

FIG. 5 shows curves F=f(T) and their adjustment by formula (6) for rhodamine and quinine: this adjustment is of excellent quality since the correlation coefficients are close to 1, being respectively C_{Rh}=0.9979 and C_{Qu}=0.9983; also found are (m1)_{Rh}=−0.01040 and (m1)_{Qu}=−0.00547, as well as (m2)_{Rh}=0.3816 and (m2)_{Qu}=0.3819.

Only those experimental points with medium and low concentration are shown. The dotted lines are the adjustments of the experimental curves with respect to theoretical formula n^{o} 6.

The correlation coefficients, denoted C, are close to 1, which confirms the adequacy of the adjustment with respect to the experimental curve. The parameters (m1)Rh and (m1)Qu are deduced therefrom, as are (m2)Rh and (m2)Qu.

The maximum luminescence emission for rhodamine lies at the wavelength λ_{Rh}=568 nm n and for quinine it is λ_{Qu}=477 nm (photoluminescence measurements made previously). The efficacies of the fluorescence detector (manufacturer's data) at these wavelengths are respectively Ed_{Rh}=37% and Ed_{Qu}=27%. The fluorescence quantum yield of quinine is deduced therefrom using equation n^{o} 9:

$$\begin{matrix}{ρ}_{Qu} = {ρ}_{Rh} \frac{{( ℏ {ω}_{f} )}_{Rh}}{{( {ℏω}_{f} )}_{Qu}} \frac{{( m 1 )}_{Qu}}{{( m 1 )}_{Rh}} \frac{{( m 2 )}_{Qu}}{{( m 2 )}_{Rh}} \frac{E {d}_{Rh}}{E {d}_{Qu}} \\ = 94 \% \frac{477}{568} \times \frac{0.00547}{0.01040} \times \frac{0.3819}{0.3816} \times \frac{37}{27} \\ = 57 \%\end{matrix}$$

The experiment was repeated with another preparation of quinine solution, at several week intervals, and similar results were found: 56%, 57% and 58%. The relative deviation compared with the value in the literature (ρ=56%) is less than 2%.

### Example 2

### Relative Measurement of the Fluorescence Quantum Yield of CdSe(ZnS) Nanocrystals

Semiconductor II-VI nanocrystals are inorganic particles 2 to 10 nm in diameter, which emit light under light excitation.

One of their potential applications is to replace organic dyes in chemistry and biology.

It is therefore of interest to compare them with organic dyes from the viewpoint of their fluorescence quantum yield.

The tested nanocrystals were obtained commercially. They are cores (shells): CdSe(ZnS) dispersed in toluene.

To obtain a less viscous solution, they are dispersed in trichloromethane. These particles emit at a wavelength of λ=626 nm.

The same procedure is followed as in example 1, obtaining an acquisition firstly for rhodamine, used as standard, then for the solution of nanocrystals. Processing of she results is also made in the same manner as in example 1. The tracing and adjustment of R=f(T) give correlation coefficients close to 1 for rhodamine and for the nanocrystals (data not shown), which validates the experiment.

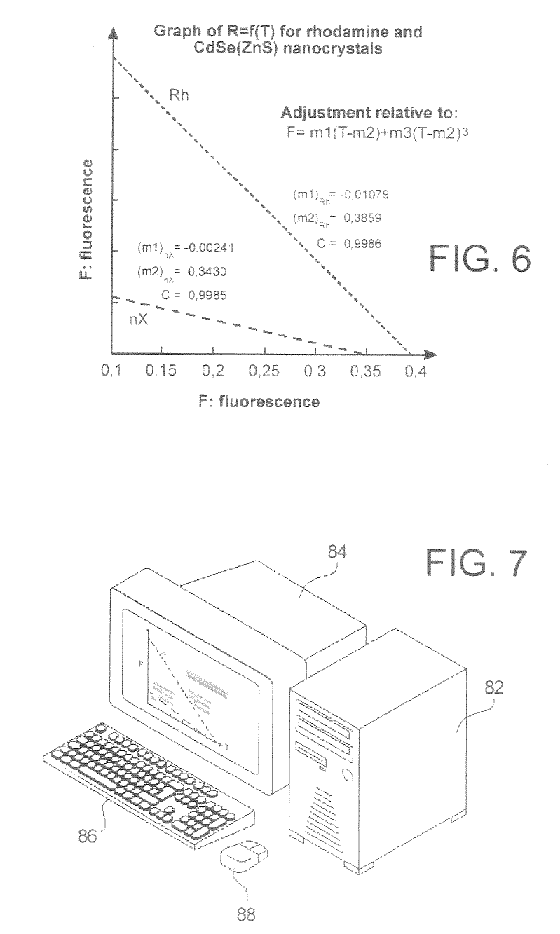

In FIG. 6, only the experimental points at medium and low concentration are shown. The dotted lines are the adjustments of the experimental curves with respect to theoretical formula n^{o} 6. The correlation coefficients, denoted C, are close to 1, respectively C_{Rh}=0.9986 for rhodamine and C_{nX}=0.9985 for the nanocrystals, which confirms the adequacy of adjustment with respect to the experimental curve. The parameters (m1)Rh and (m1)nX are deduced therefrom, as well as (m2) Rh and (m2)nX.

FIG. 6 shows the curves F=f(T) and their adjustment for rhodamine and the nanocrystals; the values (m1)_{Rh}=−0.01079 and (m1)_{nX}=−0.00241 are found, as well as (m2)_{Rh}=0.3859 and (m2)_{nX}=0.3430. The efficacies of the fluorescence detector at the corresponding wavelengths are respectively Ed_{Rh}=37% and Ed_{nX}=43%. The fluorescence quantum yield of these nanocrystals is deduced therefrom using equation n^{o} 9:

$$\begin{matrix}{ρ}_{nX} = {ρ}_{Rh} \frac{{( ℏ {ω}_{f} )}_{Rh}}{{( ℏ {ω}_{f} )}_{nX}} \frac{{( m 1 )}_{nX}}{{( m 1 )}_{Rh}} \frac{{( m 2 )}_{nX}}{{( m 2 )}_{Rh}} \frac{E {d}_{Rh}}{E {d}_{nX}} \\ = 94 \% \frac{626}{568} \times \frac{0.00253}{0.01061} \times \frac{0.3424}{0.3807} \times \frac{37}{43} \\ = 19 \%\end{matrix}$$

Another measurement on these same nanocrystals gave the same value of 19%, which confirms the preceding result.

1-31. (canceled)

32. A method for measuring relative fluorescence quantum yield of a dye, comprising:
a) for at least ten different concentrations of the dye in solution in a solvent:
exciting the dye, using electromagnetic radiation,
measuring photoluminescence of the dye excited by this radiation and of a signal transmitted through the cell containing this dye;
b) comparing the measured data with standard dye data of photoluminescence and transmission; and
c) calculating the relative fluorescence quantum yield of the dye.

33. A method according to claim 32, the solution of the dye in the solvent being diluted increasingly over time.

34. A method according to claim 32, the dye being firstly the standard dye, then the dye for which it is sought to measure the quantum yield.

35. A method according to claim 32, the measurements being made for a number of concentrations greater than 15 or 20 or 25, or lying between 10 and 100 or 500.

36. A method according to claim 32, further comprising adjusting, to a theoretical formula, fluorescence signal data and transmitted signal data.

37. A method according to claim 36, the theoretical formula being:
$$F = \frac{B {ℏω}_{f}}{\sqrt{A} {ℏω}_{i}} ρ \sqrt{T} sinh ( \frac{Δ}{L} ln ( \frac{A}{T} ) ) \qquad$$
in which F is proportional to power of the fluorescence signal, T is proportional to power of the transmitted signal, ρ is absolute fluorescence quantum yield, ω_{f} of is energy of the photons emitted by the solution, ωᵢ is energy of the incident photons, B and A are constants, and Δ and L are geometric parameters of the cell containing the dye.

38. A method according to claim 36, the theoretical formula being:
$$F = - \frac{B {ℏω}_{f}}{A {ℏω}_{i}} ρ \frac{Δ}{L} ( T - A ) + {C ( T - A )}^{3} \qquad$$
in which F is proportional to power of the fluorescence signal, T is proportional to power of the transmitted signal, ρ is absolute fluorescence quantum yield, ω_{f} is energy of the photons emitted by the solution, ωᵢ is energy of the incident photons, B. A and C are constants, and Δ and L are geometric parameters of the cell containing the dye.

39. A method according to claim 32, the relative quantum yield of the dye being obtained using the formula:
$${ρ}_{E} = {ρ}_{R} \frac{{( {ℏω}_{f} )}_{R}}{{( {ℏω}_{f} )}_{E}} \frac{{( m 1 )}_{E}}{{( m 1 )}_{R}} \frac{{( m 2 )}_{E}}{{( m 2 )}_{R}} \qquad$$
in which ω_{f} is energy of the photons emitted by the solution, ωᵢ is energy of the incident photons, m1 and m2 are parameters characteristic of changes in fluorescence in relation to the transmitted signal, indices R and E relating respectively to the standard dye and to the sample.

40. A method according to claim 32, further comprising measuring variations in intensity or power of the incident radiation on the cell, and normalizing a fluorescence signal and transmitted signal data with respect to the variations.

41. A method according to claim 32, further comprising homogenizing the dye in the cell.

42. A method according to claim 32, further comprising measuring a signal reflected by the cell containing the dye.

43. A method according to claim 41, further comprising controlling the homogeneity of the dye.

44. A method according to claim 32, the dye being organic.

45. A method according to claim 32, the dye being inorganic.

46. A method according to claim 45, the dye containing semiconductor nanocrystals.

47. A method according to claim 46, the semiconductor being of II-VI type.

48. A method according to claim 46, the semiconductor being CdSe(ZnS).

49. A method according to claim 32, including detectors to detect fluorescence and transmitted radiation, and the cell and at least part of means enabling defining of a pathway of incident radiation, being fixed with respect to each other.

50. A method according to claim 32, the measuring the photoluminescence of the dye excited by the radiation and of the signal transmitted through the cell containing the dye, and optionally measuring the reflected radiation and/or incident radiation, being simultaneous.

51. A device for measuring relative fluorescence quantum yield of a dye in solution in a solvent, comprising:
a fluorescence cell;
means to measure a fluorescence signal emitted by the excited dye and to measure a signal transmitted through the dye; and
means to calculate relative quantum yield in relation to:
data of fluorescence signals emitted by an excited dye and of a laser signal transmitted through the dye, and
data relating to a standard dye.

52. A method according to claim 51, further comprising means to cause concentration of a dye to vary in the cell in relation to time.

53. A method according to claim 51, further comprising means to measure a signal reflected by the cell.

54. A method according to claim 51, further comprising means to homogenize the dye in the cell.

55. A method according to claim 51, further comprising means to measure variations in intensity or power of incident radiation on the cell.

56. A method according to claim 51, the means to calculate adjusting the fluorescence signal data and transmitted signal data to a theoretical formula.

57. A method according to claim 56, the theoretical formula being:
$$F = \frac{B {ℏω}_{f}}{\sqrt{A} {ℏω}_{i}} ρ \sqrt{T} sinh ( \frac{Δ}{L} ln ( \frac{A}{T} ) ) \qquad$$
in which F is proportional to power of the fluorescence signal, T is proportional to power of the transmitted signal, ρ is absolute fluorescence quantum yield, ω_{f} is energy of the photons emitted by the solution, ωᵢ is energy of the incident photons, B and A are constants, and Δ and L are geometric parameters of the cell containing the dye.

58. A method according to claim 56, the theoretical formula being:
$$F = - \frac{B}{A} \frac{ {ℏω}_{f}}{ {ℏω}_{i}} ρ \frac{Δ}{L} ( T - A ) + {C ( T - A )}^{3} \qquad$$
in which F is proportional to power of the fluorescence signal, T is proportional to power of the transmitted signal, ρ is absolute fluorescence quantum yield, ω_{f} is energy of the photons emitted by the solution, ωᵢ, is energy of the incident photons, B, A and C are constants, and Δ and L are geometric parameters of the cell containing the dye.

59. A method according to claim 51, the calculation means calculating the relative quantum yield of the dye using the formula:
$${ρ}_{E} = {ρ}_{R} \frac{{( {ℏω}_{f} )}_{R}}{{( {ℏω}_{f} )}_{E}} \frac{{( m 1 )}_{E}}{{( m 1 )}_{R}} \frac{{( m 2 )}_{E}}{{( m 2 )}_{R}} \qquad$$
in which ω_{f} is energy of the photons emitted by the solution, ωᵢ is energy of the incident photons, m1 and m2 are parameters characteristic of changes in fluorescence in relation to the transmitted signal, indices R and E respectively relating to the standard dye and to the sample.

60. A method according to claim 51, the cell and the measurement means being arranged fixedly with respect to one another.

61. A method according to claim 51, further comprising means to define a direction of incidence of radiation.

62. A method according to claim 51, further comprising automated injection means to inject a dye and solvent into the cell.
